(19) United States
(12) Patent Application Publication
(10) Pub. No.: US 2011/0019830 A1
(43) Pub. Date: Jan. 27, 2011

(54) Antenna Arrangement for a Hearing Instrument

(75) Inventors: Vadim Leibman, Migdal Ha'emek (IL); Eyal Aharon, Tivon (IL)

Correspondence Address: MARSTELLER & ASSOCIATES, P O BOX 803302, DALLAS, TX, 75380-3302, US

(73) Assignee: AUDIODENT ISRAEL LTD., Omer (IL)

(21) Appl. No.: 12/933,845

(22) PCT Filed: Mar. 26, 2009
(86) PCT No.: PCT/IL2009/000349

§ 371 Date: Sep. 21, 2010

Related U.S. Application Data
(60) Provisional application No. 61/041,578, filed on Apr. 1, 2008.

(51) Int. Cl. H04R 29/00

(52) U.S. Cl. 381/60

(57) ABSTRACT

The present invention relates to a hearing instrument which comprises: (a) a housing; (b) an RF receiver; (c) plurality of conductive elements, each conductive element has the form of a plate, is positioned on said housing so it provides coupling with the device wearer's skin while the instrument is in use, thereby forming an antenna element together with the wearer's body; (d) a switch for each conductive element, for connecting or disconnecting the respective antenna element from the receiver; (e) a controller for periodically initiating a testing cycle wherein during said cycle: (e.1) the controller sequentially scans said switches by closing each time another switch, thereby to connect each time a respective antenna element to said receiver; (e.2) each time said antenna switching is performed and a specific antenna element is connected to the receiver, the controller samples and stores a respective quality indication signal which is indicative of the quality of the received signal by said receiver via said respective antenna; (e.3) the controller inspects all said stored indications, determines from all said stored indications the one that relates to a best quality signal, and connects the antenna element which corresponds to said best quality signal to said receiver for a time duration which is substantially longer than the duration of said testing cycle, until performance of a next testing cycle.

### FIELD OF THE INVENTION

The field of the invention relates in general to the field of hearing aids and hearing devices. More specifically the invention relates to an antenna arrangement for a hearing aid or hearing device which receives or transmits radio frequency (RF) signals.

### BACKGROUND OF THE INVENTION

A hearing aid or hearing device (hereinafter, both types will be referred to by the conclusive terms “hearing instruments”, or “hearing aids”) that contains RF receiver allows the user to receive sound from a remote source by means of RF communication. Some listening situations are more difficult than others for users of hearing instruments due to background noise or distance of the sound source. In such situations, wireless hearing instruments, also known as “FM systems” and “Assistive Listening Devices” (ALDs) are used in conjunction with the person's hearing aid. An FM system consists of a transmitter microphone located near the sound source and an FM receiver used by the listener. The receiver, which transfers the sound to the hearing aid through a direct audio link, may be attached to the hearing aid externally, or incorporated within the hearing aid housing. An ALD system also includes a remote microphone and a receiver linked wirelessly, yet the receiver in this case generally has a form of typical earphones, and comprises an FM receiver and audio amplifier, which conveys the audio into the person's ear. In some cases, FM system and ALD also comprise a transmitter, for transmitting signals (e.g. controls and status data) to another device. FM Systems and ALDs are typically used for improving speech understanding in challenging situations in which the sound source (e.g., speaker) is remote, such as meetings, theaters, listening to lectures or seminars, restaurants or watching TV.

A typical “FM System” used in conjunction with a hearing aid, includes a loop antenna for receiving or transmitting said RF signals. The RF receiver and the antenna may be included within the hearing aid housing itself, or within an external device which is clipped into the hearing aid (“audio shoe”). In both of said two cases, due to the small size of the hearing aid and related instruments such as the audio shoe, the RF antenna is small and its efficiency is limited, which results in poor performances (i.e. a short communication range, noise, etc.).

Binaural hearing aids (one in each ear) provide valuable and significant benefits such as better sound localization, improved speech understanding in noise, and stereo sound to people who suffer from hearing loss in both ears. In order to fully realize the benefits of binaural hearing aids, the hearing aids are synchronized in their control functions (for example, in order to provide equal sound level to both ears) as well as in the sound they process (for improved noise reduction and speech understanding). Due to usability and esthetic reasons, binaural hearing aids are linked wirelessly one with the other, however, as described above, the small size of the hearing aids limits the ability to transmit and receive high quality signals between them.

Therefore, extending RF receiver range and improving its performances in terms of better sound quality and lower noise are highly desired for hearing aids and related hearing devices.

The use of a human body as an antenna has been known for many years. For example, when one touches a TV or radio antenna, the reception, in many cases, is improved. Such use of the human body is also described in several publications. A body-coupled radio transmitter is also disclosed in the prior art.

U.S. Pat. No. 6,597,320 discloses an antenna for portable radio communication device and method of transmitting a radio signal. This patent describes an antenna which is constructed with a conductive shield plate in a housing shaped to be worn on a human body. The shield plate is capacitively coupled with a part of the human body to operate as an antenna element. A conductive cover of a battery is disposed in the housing to operate as the other antenna element. The antenna elements thus form an electric field-type dipole antenna. The conductive cover of the battery may also be capacitively coupled with the other part of the human body, so that the antenna operates as a loop antenna which uses the human body.

WO 2006/121,241 describes a terrestrial digital multimedia broadcasting (T-DMB) receiver and receiving method using a human body as an antenna. The T-DMB receiver comprises an electrode that forms contact between the human body and related electronic circuitry in a form which is easy to carry without a separate antenna.

U.S. Pat. No. 6,047,163 discloses a miniature radio apparatus in which a loop antenna is formed through the human body. More specifically, this patent describes a miniature radio apparatus for use in transmission or reception of electric waves, which has a pair of antenna terminals insulated from each other. The pair of antenna terminals are so formed as to be brought into contact with, or to be capacitively coupled to different parts of the human body, respectively. Consequently, it is possible to obtain a practical gain, and also to enlarge the range of communication so that the quality of communication is improved, without the use of an arm band antenna.

US publication 2008/0024375 describes an apparatus such as a frequency modulation (FM) radio receiver for receiving wireless signals, which has a coupling mechanism e.g. paint- or plastic-coated contact pad, which comes in contact with human skin and connected to antenna input of receiver. Parameters of the impedance matching circuitry can be adjusted based on a detected impedance, a detected signal strength, or the frequency of the signal.

Hearing aids impose several unique requirements that differ from those of other RF communication devices described in the prior art, such as:
a. Size: due to hearing aids awkward stigma, manufacturers try to make the device smaller and less visible. Hearing aids are much smaller than those devices mentioned in the prior art (radio receivers, DMB receivers, watches, etc.). Therefore, an antenna for use with hearing aids must be significantly smaller than those described in prior art.
b. Position in or behind the ear—the coupling between the hearing aid and the human body is affected, among other factors, by the movement of the device and by the presence of sweat or earwax, resulting in instability of the power and quality of the received signal. An antenna for use with a hearing aid must accommodate for such changes, so that the quality of the sound presented to the user is maintained.
c. Location relative to the transmitter—hearing aids are fixed inside or behind the ear of the user. While in other portable radio devices, such as those described in prior art, the user may move the device or the body part on which it is carried, for example, the hand, to improve the receiving efficiency and quality, it is impractical to do so with a hearing aid fixed to the ear. A movement of the user or his/her head relative to the transmitter results in significant changes to the quality of the received signal. Therefore, an antenna for use in a hearing aid must accommodate for such changes so that the quality of the sound presented to the user is maintained.
d. Sealing and sound Insulation—hearing aids must be sound-insulated to prevent sounds resulting from an acoustic feedback between the hearing aid speaker and microphone. Coupling of the human body to an RF receiver which resides inside a hearing aid must maintain such sound insulation. In addition, the hearing aid shall not be affected by sweat or other liquids as a result of external electrodes of the device.
e. Comfort and health Issues—Electrodes or contacts materials for connecting the human body to the RF receiver are used and discussed in the prior art. With hearing aids, especially those that are located inside the ear canal, such contact must: (a) be made from a bio-compatible material; (b) not create inflammation, infection or any sore; (c) not protrude beyond the outline of the hearing aid casting in order no to irritate the sensitive inner ear; and (d) not be oxidized as a result of continuous contact with the human body.

The use of the human body as an antenna as described in the prior art, does not meet these hearing aids-specific requirements. Therefore, an apparatus which uses the human body as part of an antenna for a hearing aid while meeting all these hearing aid specific requirements, and overcoming said drawbacks, is required.

It is therefore an object of the present invention to provide a receiving apparatus, which is small enough to be incorporated within hearing aids including those positioned within the ear canal, and which provides a reliable and high quality RF receiver, and optionally also RF transmitter.

It is another object of the present invention to provide a high quality antenna arrangement for a hearing aid, which is small enough to be accommodated in a hearing aid which is placed within the ear canal.

It is still another object of the present invention to provide said antenna arrangement for a hearing aid which optimizes the signal reception, even when the orientation between the hearing aid device and the RF transmitter changes.

It is still another object of the present invention to provide an arrangement for connecting antenna elements that are located outside of the hearing aid housing to the RF circuitry within the housing of the hearing aid.

It is still another object of the present invention to provide an antenna arrangement which meets all the comfort requirements listed above.

It is still another embodiment of the invention to provide an antenna arrangement for a hearing aid, which meets all the sealing and sound insulation requirements listed above.

Other objects and advantages of the present invention will become apparent as the description proceeds.

### SUMMARY OF THE INVENTION

The present invention relates to a hearing instrument which comprises:

(a) a housing; (b) an RF receiver; (c) plurality of conductive elements, each conductive element has the form of a plate, is positioned on said housing so it provides coupling with the device wearer's skin while the instrument is in use, thereby forming an antenna element together with the wearer's body; (d) a switch for each conductive element, for connecting or disconnecting the respective antenna element from the receiver; (e) a controller for periodically initiating a testing cycle wherein during said cycle: (e.1) the controller sequentially scans said switches by closing each time another switch, thereby to connect each time a respective antenna element to said receiver; (e.2) each time said antenna switching is performed and a specific antenna element is connected to the receiver, the controller samples and stores a respective quality indication signal which is indicative of the quality of the received signal by said receiver via said respective antenna; (e.3) the controller inspects all said stored indications, determines from all said stored indications the one that relates to a best quality signal, and connects the antenna element which corresponds to said best quality signal to said receiver for a time duration which is substantially longer than the duration of said testing cycle, until performance of a next testing cycle.
In an embodiment of the invention, during said testing cycle the switching of the various antenna elements is performed at such a high rate that does not cause audible noise.

In an embodiment of the invention, the duration between two testing cycles is made to accommodate for typical variations in the orientation of the hearing instrument relative to the transmitter, that result from the user movements.

In one embodiment of the invention said instrument is located in the ear of the user. In another embodiment, said instrument is located behind the ear of the user.

In one embodiment of the invention said quality indication signal is provided from the IF unit of the receiver.

In one embodiment of the invention, said wherein said quality indication signal is an RF Signal Strength Indicator (RSSI) signal.

In an embodiment of the invention, the hearing instrument comprises a second receiver, wherein the controller performs said testing cycle on said second receiver, and the results of said testing cycle are applied upon selection of the preferred antenna element of the first receiver.

In one embodiment, the conductive plates are positioned on the external surface of the housing. Alternatively, the conductive plates are positioned on the internal surface of the housing. In still another alternative, the conductive plates are embedded within the housing.

In an embodiment of the invention, said coupling is a direct contact formed between said conductive element and the wearer's skin. In another alternative, said coupling is a capacitive coupling formed between said conductive element and the wearer's skin.

In an embodiment of the invention, the inspection is performed at the end of the sequential scanning.

### BRIEF DESCRIPTION OF THE DRAWINGS

In the drawings:

FIG. 1 shows a prior art In The Ear (ITE) hearing aid;

FIG. 2 shows a prior art Behind The Ear (BTE) hearing aid;

FIG. 3 shows a prior art Behind The Ear (BTE) hearing aid which is provided with multiple external elements of conductive plate type, according to an embodiment of the present invention;

FIG. 4 shows an In The Ear (ITE) hearing aid provided with multiple external elements of conductive plate type, according to an embodiment of the present invention;

FIG. 5 schematically illustrates the assembly of a conductive plate type antenna element at the exterior of a hearing aid, according to an embodiment of the invention;

FIG. 6 is a block diagram illustrating the structure of a circuitry for controlling multiple antenna elements, according to an embodiment of the invention;

### DETAILED DESCRIPTION OF PREFERRED EMBODIMENTS

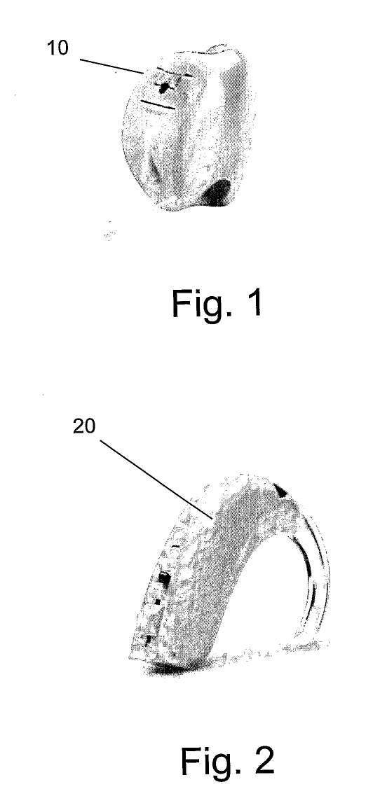

FIG. 1 illustrates a typical In-The-Ear (ITE) type hearing aid 10 of the prior art. FIG. 2 similarly illustrates a Behind-The-Ear (BTE) type hearing aid 20 of the prior art.

As mentioned, the small size of hearing aids, especially those placed within the ear, prevents incorporating high-quality FM communication capability within them, since such capability requires an antenna which is substantially larger than the size of the hearing aid itself and the need to accommodate for continuous changes in orientation of the hearing aid relative to the transmitter.

The present invention enables the incorporation of high quality RF communication, in all types of hearing aids. More specifically, the invention provides a mechanism and an improved structure for a hearing aid, which improves the device communication quality, while meeting all the requirements and limitations relating to the size, structure, and location of device.

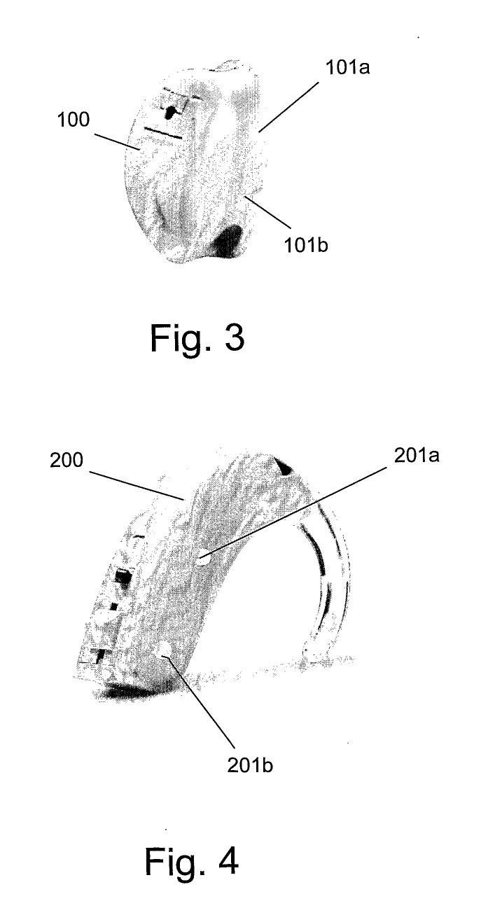

FIG. 3 shows an ITE type hearing aid 100, according to an embodiment of the present invention. The hearing aid 100 comprises plurality of conductive elements 101a and 101b, which form, when coupled with the body of the wearer, plurality of antenna elements. FIG. 4 shows a BTE type hearing aid 200 according to an embodiment of the invention, which similarly comprises plurality of conductive elements 201a and 201b, forming when coupled with the body of the wearer, plurality of antenna elements.

Each of said conductive elements is a conductive plate, which is made in a form of a very thin bio-compatible film, which is attached (for example, by means of glue) to the external or internal surface of the housing of the hearing aid, or is embedded within the external surface of said housing. Preferably, each of the conductive elements is in direct contact with a portion of the wearer's skin for maximizing the efficiency of the antenna element; however, capacitive coupling between the conductive plate and the wearer's skin, through the housing (or part thereof), can be implemented as well. It should be noted that the device of the invention may include two or more antenna elements. For example, each of the instruments of FIGS. 3 and 4 comprises 4 conductive elements that are positioned two in each opposing side of the exterior of the instrument.

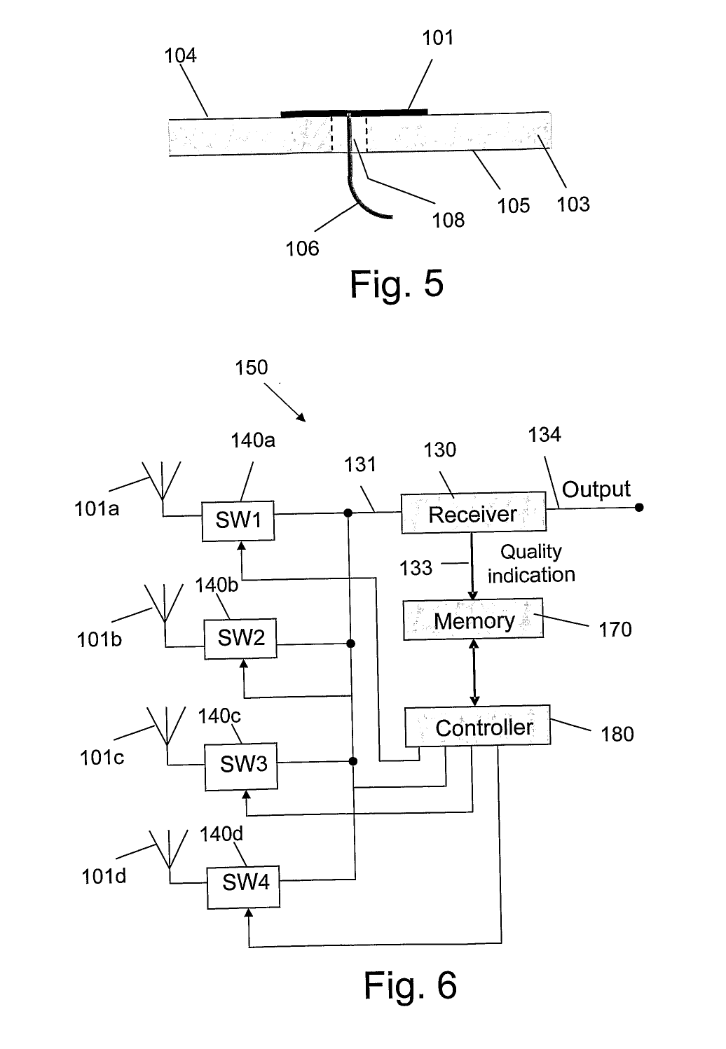

The conductive element is connected to the RF receiver (and possibly to the transmitter, when exists) which is located within the hearing aid housing. FIG. 5 schematically shows the manner by which an external conductive element is connected to the RF circuitry which resides within the hearing aid. The housing of the instrument 203 comprises an external surface 104 and internal surface 105. The conductive plate of the antenna element is attached to the external surface 104, for example by means of glue. A conductive wire 106 connects between the antenna element 101 of the device and the RF circuitry (not shown) within the hearing aid housing. The wire passes through hole 108 in the housing, which is then sealed by means of an appropriate sealing material (e.g. resin or silicon), to isolate sound as well as fluids and moisture between the exterior of the device and its interior. It should be noted that the diameter of the hole should be made slightly larger that the diameter of the wire (for example, 0.5 mm hole diameter for a wire having diameter of 0.1 mm) in order to leave some space to the sealing material, and in order to ensure elimination of noise feedback.

The location of the conductive elements (plates) on the surface of the hearing aid is determined in accordance with the following guidelines:
a. The conductive plates should be positioned where the coupling between the human body and the hearing aid housing is tight. A tight coupling between the human body and the plates is essential for proper operation;
b. The size of each conductive plate should be large enough to provide firm and continuous contact with the human skin, and yet small enough to maintain minimal protrusion out of the housing outline, and to allow placement of multiple plates on the surface of the housing. Tests and trials which have been performed by the inventors have demonstrated that a round plate of a 5 mm diameter might be optimal;
c. The conductive plates should be positioned such that the distance between them is maximized. As will be explained hereafter, the present invention comprises a circuitry for periodically monitoring the reception quality through each conductive element (which as said is preferably in contact or with good capacitive coupling with the human skin), and each time selecting one antenna element through which the reception is optimal. The RF performance of the device improves as the number of conductive plates and their distribution over the exterior of the hearing aid housing increases.

The conductive plate which is coupled to the wearer skin operates as an antenna element. A “Ground” point within the hearing aid circuitry (for example, the battery ground pole) is used as the other antenna portion, thereby creating an electric field-type dipole antenna. Alternatively, another conductive plate which is in contact with the human body may be used (instead of the Ground point), so that the antenna operates as a loop antenna with the human body linking between the two conductive plates.

As mentioned above, the location and orientation of the conductive plate (i.e., the antenna element) may have a significant effect on the performances of the antenna. For example, a received RF signal with a frequency of 800 MHz, has a wave length of about 37.5 cm, i.e. λ/4=9.4 cm. With such a wavelength of the receiving signal, two antenna elements that use conductive plates that are positioned 5 cm (typical size of a BTE hearing aid) one from the other, may provide a corresponding received signals that are significantly different in terms of the signal to noise ratio. Furthermore, the frequent change of the hearing aid location and orientation relative to the transmitter due to the user movement causes frequent change in the quality of the received signal in each of the antenna elements.

The hearing instrument of the present invention uses plurality of antenna elements that receive simultaneously the transmitted RF signal. The invention comprises signal measurement means for frequently measuring the quality of the received signal at each antenna element, determining from all the measured signals the one antenna element which provides the best quality signal, and connecting this selected antenna element to the receiver, without decreasing the quality of the information (typically, audio signal) transferred to the hearing aid through said antenna element. As mentioned, this procedure is frequently repeated such that at any given moment the specific antenna element which provides a best quality of the received signal (from among the plurality of antenna elements) is selected, and connected to the receiver. A similar mechanism is used for transmitting signals, assuming that the destination unit for the transmitted signal has previously (shortly beforehand) transmitted a signal to the present device, from which the antenna element having best reception quality can be determined. This assumes that as the previous (shortly beforehand) reception quality through a specific antenna was determined to be the best, therefore the following transmission quality to a same device will be the best. This also assumes that there was no significant change in the distance and/or orientation between said previous reception and the present transmission.

FIG. 6 schematically illustrates a basic structure of a unit 150 for selecting the best quality signal from among those received by antenna elements 101a-101d, and conveying the best quality signal to the RF receiver by connecting the respective antenna element to the RF receiver. As mentioned, the hearing aid of the invention comprises plurality of antenna elements 101a-101d, each having the form of a conductive plate which is coupled with the hearing aid wearer's skin. Each of these antenna elements is connected to the input 131 of RF receiver 130 through a corresponding switch 140a-140d. For a pole type antenna, controller 170 controls the state of the switches in such a manner that at any given time only one antenna element is connected to the receiver, while the others are disconnected, or more specifically, at any given time only one of the switches 140-140d is closed, while the rest of the switches are open. For a loop type antenna, controller 170 controls the state of the switches in such a manner that at any given time only two antenna elements are connected to the receiver, while the others are disconnected, or more specifically, at any given time only two of the switches 140-140d are closed, while the rest of the switches are open.

As mentioned, the invention selects the received signal of best quality from among those signals that are received via the plurality of antenna elements. For such determination, in one embodiment, the invention uses a quality indication signal 133, which is proportional to the signal received by the receiver from the antenna, as an indication for the efficiency of a specific antenna element and the quality of the signal that said specific antenna provides to the receiver. For example, receivers typically have RSSI indication which can be used for this purpose (i.e., as the quality indication signal). RSSI (Received Signal Strength Indication) is a generic radio receiver technology metric, which is a measurement of the power present in a received radio signal. Since RSSI taken usually in the intermediate frequency (IF) stage of the receiver, it relates to the specific band in which the information is transmitted and not to the entire spectrum. It should be noted that other methods for evaluating the efficiency of an antenna element can be used. However, the following manners for determining the quality of the received signal have been found to be non-advisable:
A. Measuring the strength of the receiver output signal may not be used since: (a) in some receivers it is not proportional to the antenna received signal (e.g. FM), and (b) an inefficient antenna element may result in high output noise, which may be incorrectly identified as a strong input signal;
B. Measuring the RF input signal may include high levels of noise or other undesired information which shall not affect the selection of the proper antenna element. For example, a receiver for audio applications may receive an RF input signal that includes high levels of signals that are out of the hearing frequency band (200-20,000 Hz), for example, low frequency noise (50 Hz) or high frequency noise (1 MHz). An appropriate quality determination manner may be based on the power of the signal of the transmitted information, while omitting unwanted frequencies and related noise.

In the embodiment of FIG. 6, the RSSI signal of the receiver is connected to memory 180. It should be noted that such memory may be digital or analog. Controller 170 sets only one of the antenna elements 101a-101d active at any point in time (i.e. connected to the receiver 130) by means of closure of a corresponding switch 140a-140d. For example, at a specific time, switch 140a is closed and antenna element 101a is active (i.e. connected to the receiver) while the other antenna elements are disconnected from the receiver (i.e., inactive). Controller 170 performs periodically a quality testing cycle in order to determine the specific antenna element which provides a best quality signal. During said testing cycle, controller 170 “scans” all the plurality of switches. More specifically, the controller first closes a first switch (while the rest are open), and the RSSI signal 133 (or in the more general case the quality indication signal) is entered into the memory 180 as M₁. Then, controller 170 opens switch SW₁ and closes SW₂, thereby connecting antenna element 140b, while the rest of the antenna elements are disconnected from receiver 130. The RSSI signal relating to the reception via antenna element 101b is then entered into the memory 180 as M₂. The same procedure repeats with respect to antenna elements 101c and 101d. Upon completion of the testing cycle, memory values relating to the various received signals quality levels via the plurality of the antenna elements respectively are stored in memory. Having these stored values, controller 170 compares between them, and selects the highest value, i.e., the one that corresponds to the antenna element that indicates the best performance. Said selection follows by the closure of the corresponding switch, and activation of the related antenna element which conveys a best quality signal to the receiver.

The testing cycle as described above is initially performed upon activation of the receiver (i.e., at power up), as well as periodically thereafter. The duration of the testing cycle is very short relative to the regular operation period in order not to reduce the quality of the received information (e.g. audio signal). The rate in which such testing cycle is performed may be determined according to the following guidelines:
a. Sufficient time should be allowed for the receiver to receive a signal from a newly selected antenna element in order to provide an appropriately indicative RSSI signal (or in general terms quality indication signal).
b. The switching cycle should be short enough in order not to be evident to the user (for example, in case that an antenna element outputs a poor signal quality, the object is to make the period short enough such that a poor quality signal will not be sensed by the user).
c. Switching mechanism shall not create noise that can be heard by the user (i.e. in the range of 200 Hz-20,000 Hz)
d. The duration between two testing procedures should be related to the expected variations in reception, which are caused mainly by the movement of the user and its body, relative to the transmitter. The rate of such movements is much slower than the testing cycle duration.

For example, tests of the embodiment of FIG. 6 have shown that a testing cycle which switches antenna elements every 0.1 millisecond is transparent to (i.e. not felt by) the hearing aid user and does not generate audible noise, while performing such testing cycle every 1 second (1 Hz rate) accommodates for most body movements and changes in reception quality. However, these durations are only recommendation and may vary. For example, the testing cycle may last between 0.05 millisecond and 2 millisecond, and the duration between testing cycles may vary between 0.1 second and 2 seconds or more.

It should be noted that the invention is applicable also for the case where the receiver is located outside of the hearing instrument, for example, when an “audio shoe” is used

The embodiment of FIG. 6 discloses an arrangement for a hearing aid which uses only one receiver, while the testing cycle is applied in such a short period which is transparent to the user. This embodiment has the advantage of using only a single receiver, which reduces (a) costs; (b) space which is a very important factor when considering the limited available space within the hearing device (particularly of the ITE type); and (c) power consumption. However, it should be evident that the invention may also use two receivers, a first main receiver for the normal operation and a secondary receiver “at the background” whose function is to determine for said main receiver at any given time the optimal antenna element to use. However, said latter embodiment does not gain from the above advantages (a)-(c) as of the embodiment of FIG. 6.

While some embodiments of the invention have been described by way of illustration, it will be apparent that the invention can be carried out with many modifications, variations and adaptations, and with the use of numerous equivalents or alternative solutions that are within the scope of persons skilled in the art, without departing from the spirit of the invention or exceeding the scope of the claims.

1. A hearing instrument which comprises:
a. a housing;
b. an RF receiver;
c. plurality of conductive elements, each conductive element has the form of a plate, is positioned on said housing so it provides coupling with the device wearer skin while the instrument is in use, thereby to form an antenna element together with the wearer's body;
d. a switch for each conductive element, for connecting or disconnecting the respective antenna element from the receiver;
e. a controller for periodically initiating a testing cycle wherein during said cycle:
e.1. the controller sequentially scans said switches by closing each time another switch, thereby to connect each time a respective antenna element to said receiver;
e.2. each time said antenna switching is performed and a specific antenna element is connected to the receiver, the controller samples and stores a respective quality indication signal which is indicative of the quality of the received signal by said receiver via said respective antenna;
e.3. the controller inspects all said stored indications, determines from all said stored indications the one that relates to a best quality signal, and connects the antenna element which corresponds to said best quality signal to said receiver for a time duration which is substantially longer than the duration of said testing cycle, until performance of a next testing cycle.

2. A hearing instrument according to claim 1, wherein during said testing cycle the switching of the various antenna elements is performed at such a high rate that does not cause audible noise.

3. A hearing instrument according to claim 1, wherein the duration between two testing cycles is made to accommodate for typical variations in the orientation of the hearing instrument relative to the transmitter, that result from the user movements.

4. A hearing instrument according to claim 1, wherein said instrument is located in the ear of the user.

5. A hearing instrument according to claim 1, wherein said instrument is located behind the ear of the user.

6. A hearing instrument according to claim 1, wherein said quality indication signal is provided from the IF unit of the receiver.

7. A hearing instrument according to claim 1, wherein said quality indication signal is an RSSI signal.

8. A hearing instrument according to claim 1, which comprises a second receiver, wherein the controller performs said testing cycle on said second receiver, and the results of said testing cycle are applied upon selection of the preferred antenna element of the first receiver.

9. A hearing instrument according to claim 1, wherein the conductive plates are positioned on the external surface of the housing.

10. A hearing instrument according to claim 1, wherein the conductive plates are positioned on the internal surface of the housing.

11. A hearing instrument according to claim 1, wherein the conductive plates are embedded within the housing.

12. A hearing instrument according to claim 1, wherein said coupling is a direct contact formed between said conductive element and the wearer's skin

13. A hearing instrument according to claim 1, wherein said coupling is a capacitive coupling formed between said conductive element and the wearer's skin.

14. Hearing instrument according to claim 1, wherein the inspection is performed at the end of the sequential scanning.
